(19) United States
(12) Patent Application Publication
(10) Pub. No.: US 2025/0056618 A1
(43) Pub. Date: Feb. 13, 2025

(54) UE, NETWORK NODE AND METHODS FOR HANDLING UPLINK ACCESS PROCEDURES IN A COMMUNICATIONS SYSTEM

(71) Applicant: Telefonaktiebolaget LM Ericsson (publ), Stockholm (SE)

(72) Inventors: Andreas HÖGLUND, SOLNA (SE); Tuomas TIRRONEN, HELSINKI (FI); Henrik ENBUSKE, STOCKHOLM (SE); Jan CHRISTOFFERSSON, LULEÅ (SE)

(21) Appl. No.: 18/718,908

(22) PCT Filed: Nov. 17, 2022
(86) PCT No.: PCT/SE2022/051073

§ 371 Date: Jun. 12, 2024

Related U.S. Application Data
(60) Provisional application No. 63/265,497, filed on Dec. 16, 2021.

(51) Int. Cl. H04W 74/0833; H04W 76/27; H04W 76/38

(52) U.S. Cl. CPC H04W 74/0833; H04W 76/27; H04W 76/38

(57) ABSTRACT

The present disclosure relates to a method performed by a network node for handling uplink access procedures in a communications system. The network node determines which type of uplink access procedure a UE should use for data transmission. The type is a MT type or a legacy type. The network node provides a message to the UE. The message comprises an indication of the determined uplink access procedure to the UE if it is determined that the UE should use the MT type.

### TECHNICAL FIELD

The present disclosure relates generally to a User Equipment (UE), a method performed by the UE, a network node and a method performed by the network node.

More particularly, the present disclosure relates to handling uplink (UL) access procedures in a communications system. The present disclosure relates to an indication of uplink access procedure for Mobile Terminated-Small Data Transmission (MT-SDT).

### BACKGROUND

### New Radio (NR) Small Data Transmissions in Inactive State

There is ongoing work related to NR small data transmissions in INACTIVE state with the focus of optimizing the transmission for small data payloads by reducing the signaling overhead.

The ongoing work enables small data transmission in Radio Resource Control (RRC) INACTIVE state as follows:
UL small data transmissions for Random Access Channel (RACH) based schemes, i.e. 2-step and 4-step RACH:
   General procedure to enable User Plane (UP) data transmission for small data packets from INACTIVE state, e.g. using Message A (MsgA) or Message 3 (Msg3).
   Enable flexible payload sizes larger than the Release 16 (Rel-16) Common Control Channels (CCCH) message size that is possible currently for INACTIVE state for MsgA and Msg3 to support UP data transmission in UL. The actual payload size may be up to the network configuration.
   Context fetch and data forwarding with and without anchor relocation in INACTIVE state for RACH based solutions.
Transmission of UL data on pre-configured Physical Uplink Shared Channel (PUSCH) resources, i.e. reusing the configured grant type 1,—when Timing Advance (TA) is valid:
   General procedure for small data transmission over configured grant type 1 resources from INACTIVE state.
   Configuration of the configured grant type1 resources for small data transmission in UL for INACTIVE state.

For Narrowband-Internet of Things (NB-IoT) and Long Term Evolution Machine Type Communication (LTE-M) similar signaling optimizations for small data have been introduced through Release-15 (Rel-15) Early Data Transmission (EDT) and Rel-16 Preconfigured Uplink Resources (PUR). One difference for the New Radio Small Data Transmission (NR SDT) solutions is that the Release 17 (Rel-17) NR Small Data is only to be supported for RRC INACTIVE state, that it includes also 2-step RACH based small data, and that it should also include regular complexity Mobile Broadband (MBB) UEs. Both support Mobile Originated (MO) traffic only. NR SDT also unlike Long Term Evolution Early Data Transmission (LTE EDT) support transmission of subsequent data, that is larger payload sizes which require more than one transmission.

Random Access-Small Data Transmission (RA-SDT) means that either legacy 4-step RACH or 2-step RACH procedure is used as a baseline but that a user-plane data payload can be appended, multiplexed with the RRCResumeRequest message, in Msg3 or MsgA. Configured Grant-Small Data Transmission (CG-SDT) means that the UEs configured via RRC to have periodic CG-SDT occasions which can, contention-free, be used for uplink transmission. In this way Msg1 and Msg2 can be omitted but it is a requirement that the UE has a valid TA and is uplink synchronized to be able to use the resources for transmission.

For LTE, support for mobile terminate (MT) was introduced later in Rel-16, that is supporting transmissions of small data payloads in the downlink. Now for NR, MT-SDT is being introduced in Release 18 (Rel-18). There is ongoing work related to MT-SDT with the following objectives:
Specify the support for paging-triggered SDT, e.g. MT-SDT.
MT-SDT triggering mechanism for UEs in RRC_INACTIVE, supporting RA-SDT and CG-SDT as the UL response.
MT-SDT procedure for initial Downlink (DL) data reception and subsequent UL/DL data transmissions in RRC_INACTIVE.

The intention with the ongoing work related to MT-SDT is to, as for LTE MT-EDT, include an indication to the UE in the paging message that the g Node B (gNB) has downlink small data intended for the UE. Further, the intention is that the UE at the reception of this indication re-uses either of the Rel-17 MO SDT mechanisms for the accessing the cell or resuming the connection to be able to transmit and/or receive data, i.e. the part on “supporting RA-SDT and CG-SDT as the UL response” in the objectives. There are at least two problems associated with this, first it would be unclear to the UE if RA-SDT or CG-SDT should be used, and second CG-SDT may be configured with relatively long periodicity which would cause a (too) long downlink latency for the overall MT-SDT procedure.

Therefore, there is a need to at least mitigate or solve this issue.

### SUMMARY

An objective is to obviate at least one of the above disadvantages and to provide improved handling of uplink access procedures in a communications system.

According to a first aspect, the object is achieved by a method performed by a network node for handling uplink access procedures in a communications system. The network node determines which type of uplink access procedure the UE should use for data transmission, wherein the type is a MT type or a legacy type. The network node provides a message to the UE. The message comprises an indication of the determined uplink access procedure to the UE if it is determined that the UE should use the MT type.

According to a second aspect, the object is achieved by a method performed by a UE for handling uplink access procedures in a communications system. The UE obtains a message from a network node. The message comprises an indication of an uplink access procedure if the UE should use a MT type. The UE determines, based on the message, which uplink access procedure the UE should be used for data transmission. The type is the MT type or a legacy type. The UE triggers the transmission using the determined uplink access procedure.

Thanks to the message comprising the indication of the determined uplink access procedure if it is determined that the UE should use the MT type, the handling of uplink access procedures in a communications system is improved. With the indication, it is clear to the UE which procedure it should use. No incorrect procedure will be used. Furthermore, the network node may have control of which procedure the UE uses.

The present disclosure herein affords many advantages, of which a non-exhaustive list of examples follows:

An advantage of the present disclosure is to enable the network node to have more control of how the UE accesses the communication system, for example after MT-SDT. That is, the network node can control which data transmission procedure the UE should trigger and use, e.g. whether RA-SDT or CG-SDT should be triggered and used by the UE.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating a communications system.

FIG. 2 is a flow chart illustrating a method.

FIG. 3 is a flow chart illustrating a method.

FIG. 4 is a flow chart illustrating a method.

FIG. 5 is a flow chart illustrating a method.

FIG. 6 is a flow chart illustrating a method.

FIG. 7 is a flow chart illustrating a method.

FIG. 8 is a flow chart illustrating a method.

FIG. 9 is a flow chart illustrating a method performed by the network node.

FIG. 10 is a flow chart illustrating a method performed by the UE.

FIG. 11a is a schematic drawing illustrating a UE.

FIG. 11b is a schematic drawing illustrating a UE.

FIG. 12a is a schematic drawing illustrating a network node.

FIG. 12b is a schematic drawing illustrating a network node.

FIG. 13 is a schematic block diagram illustrating a telecommunication network connected via an intermediate network to a host computer.

FIG. 14 is a schematic block diagram of a host computer communicating via a base station with a UE over a partially wireless connection.

FIG. 15 is a flowchart depicting a method in a communications system comprising a host computer, a base station and a UE.

FIG. 16 is a flowchart depicting a method in a communications system comprising a host computer, a base station and a UE.

FIG. 17 is a flowchart depicting a method in a communications system comprising a host computer, a base station and a UE.

FIG. 18 is a flowchart depicting a method in a communications system comprising a host computer, a base station and a UE.

The drawings are not necessarily to scale, and the dimensions of certain features may have been exaggerated for the sake of clarity. Emphasis is instead placed upon illustrating the principle.

### DETAILED DESCRIPTION

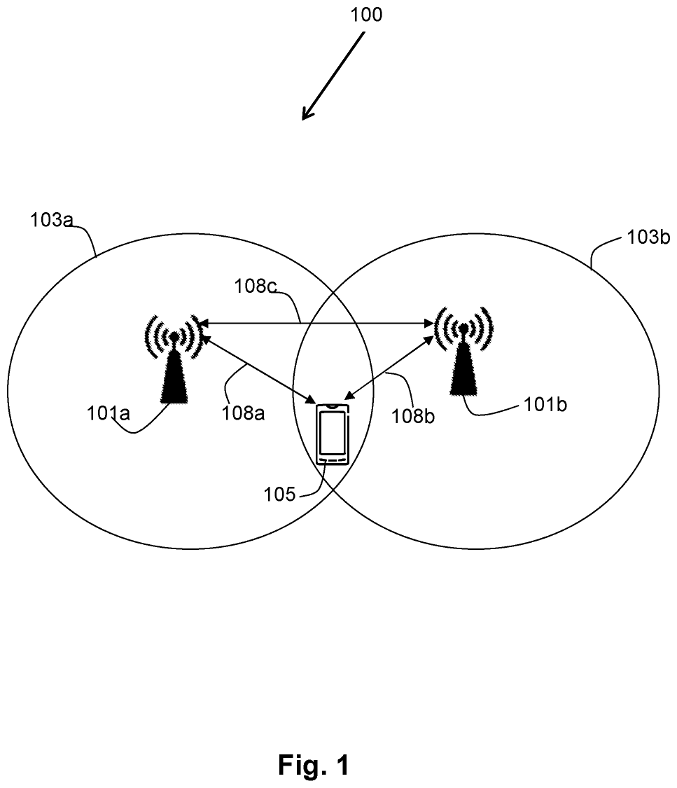

FIG. 1 depicts a non-limiting example of a communications system 100, which may be a wireless communications system, sometimes also referred to as a wireless communications network, cellular radio system, or cellular network, in which the present disclosure may be implemented. The communications system 100 may be a Fifth Generation (5G) system, 5G network, New Radio Unlicensed (NR-U) or Next Generation system or network. The communications system 100 may alternatively be a younger system or older system than a 5G system, such as e.g. a Second Generation (2G) system, a Third Generation (3G) system, a Fourth Generation (4G) system, a Sixth Generation (6G) system, a Seventh Generation (7G) system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in the non-limiting example of FIG. 1. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an evolved Node B (eNB) and the second network node 101b may be a gNB. The first network node 101a may be a first eNB, and the second network node 101b may be a second eNB. The first network node 101a may be a first gNB, and the second network node 101b may be a second gNB. The first network node 101a may be a Master eNB (MeNB) and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas, wherein each cell area may be served by a network node, although, one network node may serve one or several cells. In FIG. 1, the communications system 100 comprises a first cell 103a and a second cell 103b. Note that two cells are exemplified in FIG. 1 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 1, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 1 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e. it refers to any of the first cell 103a or second cell 103b.

One or a plurality of UEs 105 is comprised in the communication system 100. Only one UE 105 is exemplified in FIG. 1 for the sake of simplicity. A UE 105 may also be referred to simply as a device. The UE 105, e.g. an LTE UE or a 5G/NR UE, it may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IoT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, M2M device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g. between two UEs 105, between a UE 105 and a regular telephone, between the UE 105 and a network node, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer, e.g. as indicated by the Open Systems Interconnection (OSI) model, as understood by the person skilled in the art.

For LTE MT-EDT, an indication is comprised in the paging message to inform the UE that the network node 101, e.g. the eNB, gNB, has the intention to transmit EDT in the downlink. The UE 105 will then trigger the EDT procedure, i.e. select an EDT preamble, receive Msg2, transmit Msg3 in accordance with the EDT procedure, and finally receive the downlink payload in Msg4 multiplexed with the RRCRelease message which terminates the procedure.

For MT-SDT, a 1 bit indication in the paging message, as used for the LTE MT-EDT solution, would not be sufficient for the UE 105 to determine whether it should use RA-SDT or CG-SDT. Further, in case of CG-SDT selection, the CG-SDT has typically been configured for an uplink service with a certain periodicity and may not at all be the case that this is suitable for MT-SDT response. The maximum possible CG-SDT uplink grant periodicity has not yet been decided in the Third Generation Partnership Project (3GPP) but it is expected to be longer than the maximum periodicity when configuring the legacy configured grants. For Rel-15 and Rel-16, the configured grant in RRC_CONNECTED can e.g. be up to 640 ms for 15 kHz Sub Carrier Spacing (SCS). Therefore, using CG-SDT for the UL response when MT-SDT is triggered could lead to a downlink latency of several seconds in some cases, which may not be acceptable or unwanted. Therefore it is not clear how the UE 105, at the reception of a MT-SDT indication in the paging message, should determine if it should initiate RA-SDT or CG-SDT transmission as a response.

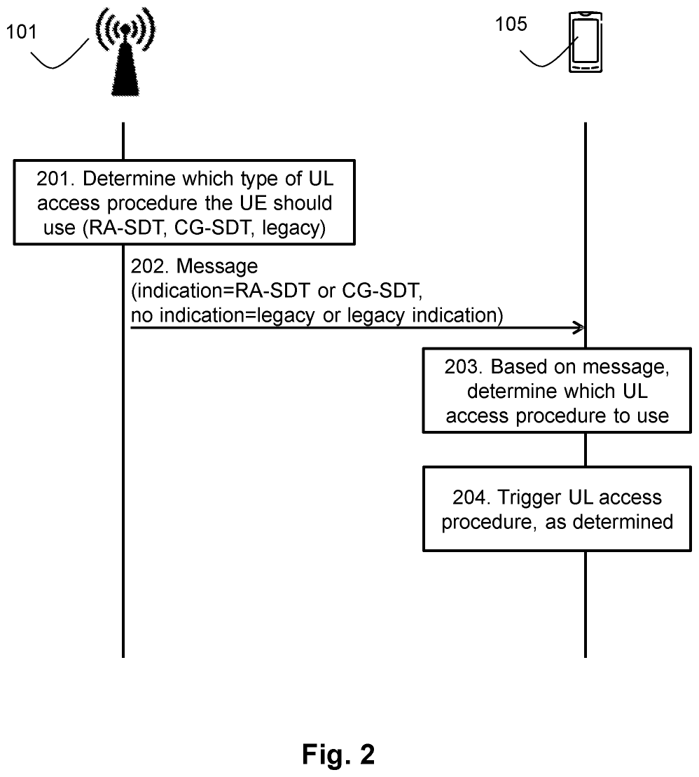

FIG. 2 is a signaling diagram illustrating a method. The method comprises at least one of the following steps, which steps may be performed in any suitable order than described below:

### Step 201

The network node 101 determines which type of UL access procedure the UE 105 should use. The UL access procedure may be a first UL access procedure or a second UL access procedure. The UL access procedure may be for example RA-SDT, CG-SDT or a legacy UL access procedure. The UL access procedure may be a paging procedure.

The UL access procedure may be for a UL data transmission. The data to be transmitted UL may be SDT, EDT or some other type of data.

The network node 101 may be adapted to be a serving network node, i.e. a network node which currently serves the UE 105.

### Step 202

The network node 101 provides, e.g. sends or transmits, a message to the UE 105. The message may be provided as a result of the determining in step 201. One purpose of the message may be to inform the UE 105 about which UL access procedure to use.

In one embodiment, the message may comprise an indication or it may comprise no indication. The indication may indicate which UL access procedure the UE 105 should use, i.e. as determined by the network node 101 in step 201. The indication may indicate RA-SDT or CG-SDT. The indication may be a MT indication or a MT-SDT indication. If the message does not comprise the indication, then this may be interpreted by the UE 105 as to perform a legacy UL access procedure. Thus, an absence of the indication may indicate that a legacy UL access procedure should be triggered.

In another embodiment, the message may comprise a first indication or a second indication. The first indication may indicate which UL access procedure the UE 105 should use, i.e. as determined by the network node 101 in step 201. The first indication may indicate RA-SDT or CG-SDT. The second indication may indicate that the UE 105 should perform a legacy UL access procedure. The second indication may be a legacy indication. The legacy indication may be equivalent to the absence of the MT indication or the MT-SDT indication.

Thus, absence of the indication, e.g. the MT indication or the MT-SDT indication, or the presence of a second indication may indicate that the UE 105 should perform the legacy UL access procedure.

The UE 105 obtains the message, with or without the indication(s), from the network node 101.

The message may be a paging message.

### Step 203

Based on the message from step 202, the UE 105 determines which type of UL access procedure to use for data transmission. The type is the MT type or a legacy type of UL access procedure.

In one embodiment, if the message comprises an indication of RA-SDT, then the UE 105 may determine that it should use the RA-SDT procedure. If the message comprises an indication of CG-SDT, then the UE 105 may determine that it should use the RA-SDT procedure. If the message does not comprise any indication of a UL access procedure, then the UE 105 may determine that it should use a legacy UL access procedure.

In another embodiment, if the message comprises the first indication indicating CG-SDT or RA-SDT, then the UE 105 may determine that it should use the indicated procedure. Or if the message comprises the second indication, then the UE 105 may determine that it should use a legacy UL access procedure. The second indication may be a legacy indication.

The legacy UL access procedure may be for example legacy 4-step RACH or 2-step RACH procedure.

Thus, the UE 105 determines which type of UL access procedure to use for data transmission based on that one or more conditions are fulfilled.

### Step 204

The UE 105 triggers the data transmission using the UL access procedure, as determined in step 203. This may be described as the UE 105 performs the determined UL access procedure. The UL access procedure may be a first UL access procedure or a second UL access procedure.

### Dynamic Indication

In one embodiment, a 2-bit or multi-bit indication may be used in the paging message, i.e. the message exemplified in step 202 in FIG. 2, to dynamically indicate to the UE 105 whether it should use RA-SDT or CG-SDT. An ASN.1 example for how this could be encoded in RRC signaling is given below, where the MT indication with value ‘cgSdt’ indicates to the UE 105 that it would use its CG-SDT resources configured, the MT indication with value ‘raSdt’ means that the UE 105 should trigger RA-SDT, and the absence of the Information Element (IE) mt-SDT means that MT-SDT is not being triggered or used. Thus, in the paging message, it is indicated that, for a particular UE 105 which procedure it should use when replying to a MT-SDT indication.

The indication may be dynamic in the sense that more details, parameters, information etc. is comprised in the MT-indication. I.e. it may be indicated if the UE 105 should do RA-SDT or CG-SDT.

The paging message may be as follows:>Insert page 12a

Note that some of the methods described herein uses an example where the presence of the indication in the message indicates that the UE 105 should triggering the RA-SDT or CG-SDT procedures, and that the absence of the indication in the message indicates that the UE 105 should trigger the legacy procedure. However, the methods described herein are equally applicable to an embodiment where the presence of a first indication in the message indicates the RA-SDT or CG-SDT procedures and the presence of a second indication indicates the legacy procedure, but this will not be described herein in detail for the sake of simplicity.

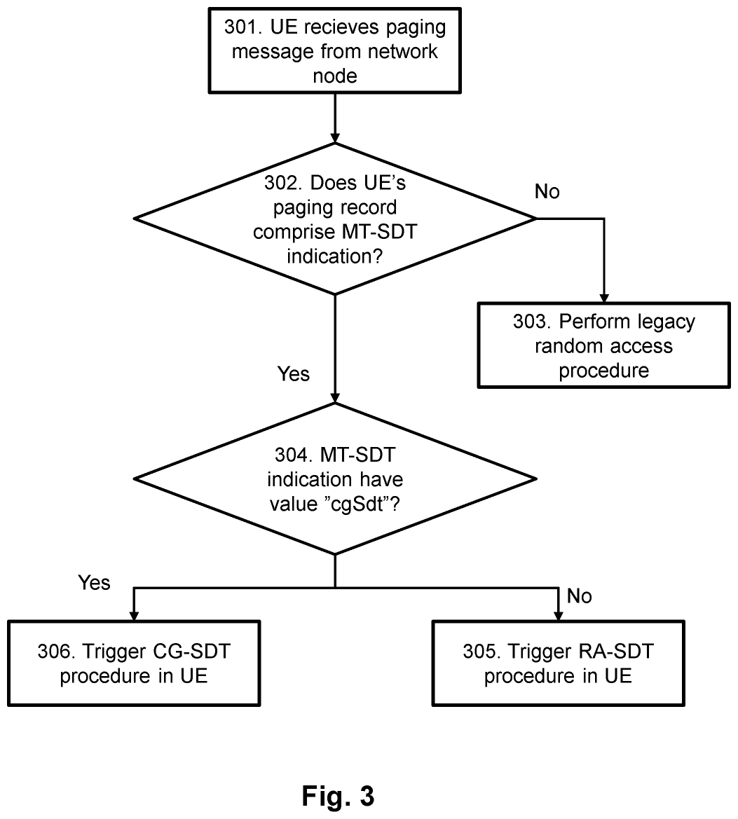

FIG. 3 is a flow charge illustrating a method performed by the UE 105. Prior to the first step in FIG. 3, the network node 101 has performed steps which corresponds to steps

-- ASN1START
-- TAG-PAGING-START

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | SEQUENCE{ } | OPTIONAL |

}

| Paging-v18xy-IEs ::= | SEQUENCE { | |
|---|---|---|
| pagingRecordList-v18xy | PagingRecordList-v18xy | OPTIONAL, -- Need N |
| nonCriticalExtension | SEQUENCE { } | OPTIONAL |

}

| | |
|---|---|
| PagingRecordList ::= | SEQUENCE (SIZE(1..maxNrofPageRec)) OF PagingRecord |
| PagingRecordList-v18xy ::= | SEQUENCE (SIZE (1..maxNrPageRec)) OF Paging Record |

v18xy

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}

| PagingRecord-v18xy ::= | SEQUENCE { | |
|---|---|---|
| mt-SDT-r18 | ENUMERATED {raSdt, cgSdt} | OPTIONAL -- Need N |

}

| | |
|---|---|
| PagingUE-Identity ::= | CHOICE { |
| ng-5G-S-TMSI | NG-5G-S-TMSI, |
| fulll-RNTI | I-RNTI-Value, |

...
}
-- TAG-PAGING-STOP
-- ASN1STOP

201 and 202 in FIG. 2 described above. FIG. 3 illustrates a dynamic indication. The method comprises at least one of the following steps, which steps may be performed in any suitable order than described below:

### Step 301

This step corresponds to step 202 in FIG. 2. The UE 105 receives a message from the network node 101. The message may be a paging message.

### Step 302

This step corresponds to step 203 in FIG. 2. Upon reception of the message in step 301, the UE 105 determines if the message comprises an indication. The indication may be a MT-STD indication. The indication may be comprised in a paging record comprised in the message. If the message comprises an indication, then the method proceeds to step 304, as indicated with “yes” in FIG. 3. If the message does not comprise the indication, then the method proceeds to step 303, as indicated with “no” in FIG. 3.

### Step 303

This step corresponds to step 204 in FIG. 2. This step may be performed if the message does not comprise the indication. The UE 105 may perform a legacy procedure, e.g. a legacy paging procedure, a legacy random access procedure etc. The paging procedure may be a random access procedure

### Step 304

This step corresponds to step 203 in FIG. 2. This step may be performed if the message comprises the indication. The UE 105 may check if the indication has a first value. The first value may be cgSdt or it may indicate that the CG-SDT procedure is to be triggered. A second value may be for example raSdt.

If the indication has the first value, then the UE 105 may perform step 306, as indicated with “yes” in FIG. 3. If the indication does not have the first value, then the UE 105 may perform step 305, as indicated with “no” in FIG. 3

Step 304 may be applicable to different values and/or procedures.

### Step 305

This step corresponds to step 204 in FIG. 2. This step may be performed if the indication does not have the first value. The UE 105 may trigger the RA-SDT procedure.

### Step 306

This step corresponds to step 204 in FIG. 2. This step may be performed if the indication has the first value. The UE 105 may trigger the CG-SDT procedure.

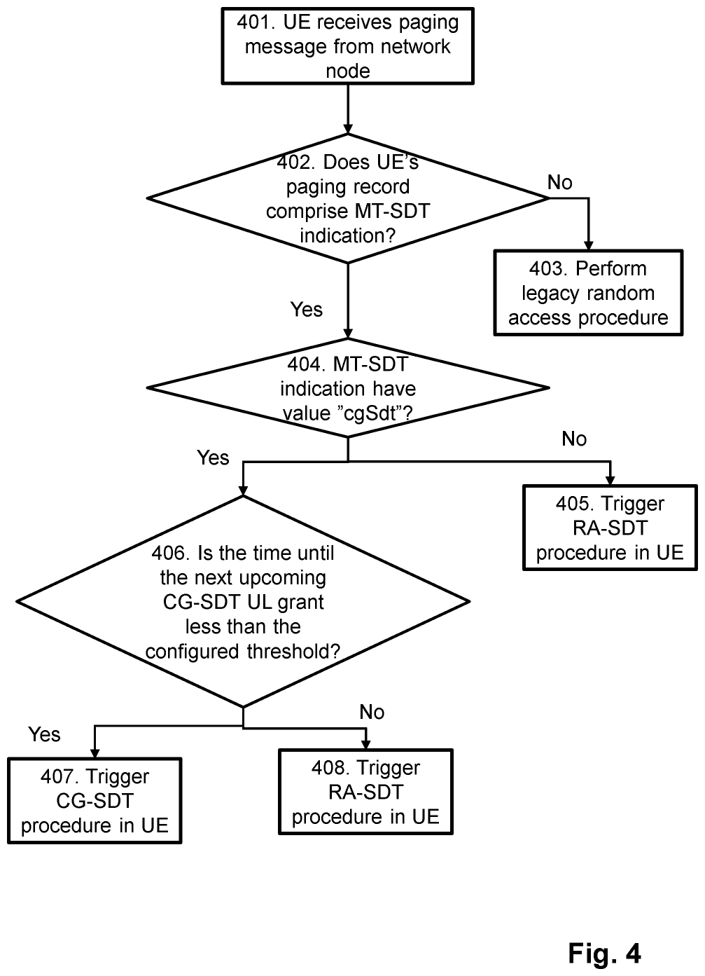

An alternative to FIG. 3 is illustrated in FIG. 4. In the example in FIG. 4, the indication may be further combined with a condition that the time to the next upcoming CG-SDT UL grant is less than a threshold. The threshold may be a configurable threshold. An additional step, i.e. step 406, would then be added to the procedure as compared to FIG. 3. FIG. 4 is a flow chart illustrating a method performed by the UE 105. Prior to the step 401 in FIG. 4, the network node 101 has performed steps which corresponds to steps 201 and 202 in FIG. 2 described above. FIG. 4 illustrates a dynamic indication. The method in FIG. 4 comprises at least one of the following steps, which steps may be performed in any suitable order than described below:

### Step 401

This step corresponds to step 202 in FIG. 2 and step 301 in FIG. 3. The UE 105 receives a message from the network node 101. The message may be a paging message.

### Step 402

This step corresponds to step 203 in FIG. 2 and step 302 in FIG. 3. Upon reception of the message in step 401, the UE checks if the message comprises an indication. The indication may be a MT-STD indication. The indication may be comprised in a paging record comprised in the message. If the message comprises an indication, then the method proceeds to step 404, as indicated with “yes” in FIG. 4. If the message does not comprise the indication, then the method proceeds to step 403, as indicated with “no” in FIG. 4.

### Step 403

This step corresponds to step 204 in FIG. 2 and step 303 in FIG. 3. This step may be performed if the message does not comprise the indication. The UE 105 may perform a legacy procedure, e.g. a legacy paging procedure, a legacy random access procedure. The paging procedure may be a random access procedure.

### Step 404

This step corresponds to step 203 in FIG. 2 and step 304 in FIG. 3. This step may be performed if the message comprises the indication. The UE 105 may check if the indication has a first value. The first value may be cgSdt or it may indicate that the CG-SDT procedure is to be triggered.

If the indication has the first value, then the UE 105 may perform step 406, as indicated with “yes” in FIG. 4. If the indication does not have the first value, then the UE 105 may perform step 405, as indicated with “no” in FIG. 4

Step 404 may be applicable to different values and/or procedures.

### Step 405

This step corresponds to step 204 in FIG. 2 and step 305 in FIG. 3. This step may be performed if the indication does not have the first value. The UE 105 may trigger the RA-SDT procedure.

### Step 406

This step corresponds to step 203 in FIG. 2. This step may be performed if the indication has the first value. The UE 105 may check if the time until the next upcoming CG-SDT UL grant is less than the configured threshold or not.

If the time is less than the configured threshold, then the UE 105 may perform step 407, as indicated with “yes” in FIG. 4. If not less than the configured threshold, i.e. that it is equal to or above the configured threshold, then the UE 105 may perform step 408, as indicated with “no” in FIG. 4.

A corresponding step to step 406 is not comprised in FIG. 3.

### Step 407

This step corresponds to step 204 in FIG. 2 and step 305 in FIG. 3. This step may be performed if the time is less than the configured threshold, as indicated with “yes” in FIG. 4. The UE 105 may trigger the CG-SDT procedure.

### Step 408

This step corresponds to step 204 in FIG. 2 and step 305 in FIG. 3. This step may be performed if the time is not less than the configured threshold, as indicated with “no” in FIG. 4. The UE 105 may trigger the RA-SDT procedure.

In one example, the configured threshold may be carried in the paging message, enabling a differentiated treatment between UEs 105 and for different priority of the DL data. In another example, the configured threshold may be indicated in broadcast system information (SI). In another example, the threshold may be provided in dedicated RRC signaling.

In one example, the MT-indication may indicate the use of an active unicast SDT (specific) Bandwidth Part (BWP) with common search space configured by a System Information Block (SIB) or Paging Search Space e.g. in cases where the unicast and broadcast beams are overlapping.

In one example, the MT-Indication may include an indication on the use of another MT-SDT specific Discontinuous Reception (DRX) cycle in order to enable lower delay in future MT-Indication reception.

In one example, the MT-Indication may indicate whether all radio bearers may be re-established for use of SDT, or only radio bearers configured for SDT are re-established and resumed whilst the UE remains in RRC_INACTIVE state for the duration of the SDT procedure initiated by the MT-SDT indication.

### Semi-Static Indication

STD is only applicable in RRC_INACTIVE state and may therefore be configured per UE 105 via dedicated RRC signaling. Rel-17 CG-SDT is for example configured for the UE 105 in the RRCRelease message when releasing the connection, i.e. the UE 105 is in RRC_CONNECTED, preceding the RRC_INACTIVE mode where the CG-SDT configuration is applied. For Rel-17 RA-SDT, it is still not determined which parts will be configured via common RRC signaling, e.g. in system information, and which parts will be configured via dedicated RRC signaling, e.g. in the RRCRelease message. For Rel-18 MT-SDT, in one embodiment, the UE 105 may be configured to apply CG-SDT or RA-SDT in case of the MT indication in the paging message via semi-static RRC configuration. In one alternative, this configuration may be added as a Rel-18 extension to the Rel-17 CG-SDT RRC configuration which is provided to the UE 105 in the RRCRelease message. Since UEs 105 not configured with Rel-17 CG-SDT does not have the option to use CG-SDT for the MT-SDT response, there may be no reason to have the indication as part of the RA-SDT configuration and having it as part of the CG-SDT configuration is more natural. In another alternative, a new dedicated RRC configuration may be introduced for MT-SDT, possibly appended in the RRCRelease message, and the new indication, of whether RA-SDT or CG-SDT should be triggered in

UE 105 upon receiving the MT indication the paging message, may be made part of that. Note that the indication may be only relevant for UEs 105 with CG-SDT configuration, so there may be no need to for a common RRC configuration.

The indication may be semi-static in the sense that the indication in the paging message is more general, i.e. it indicates only MT. The UE 105 is then configured in the release message what algorithm or process to use upon receiving this indication.

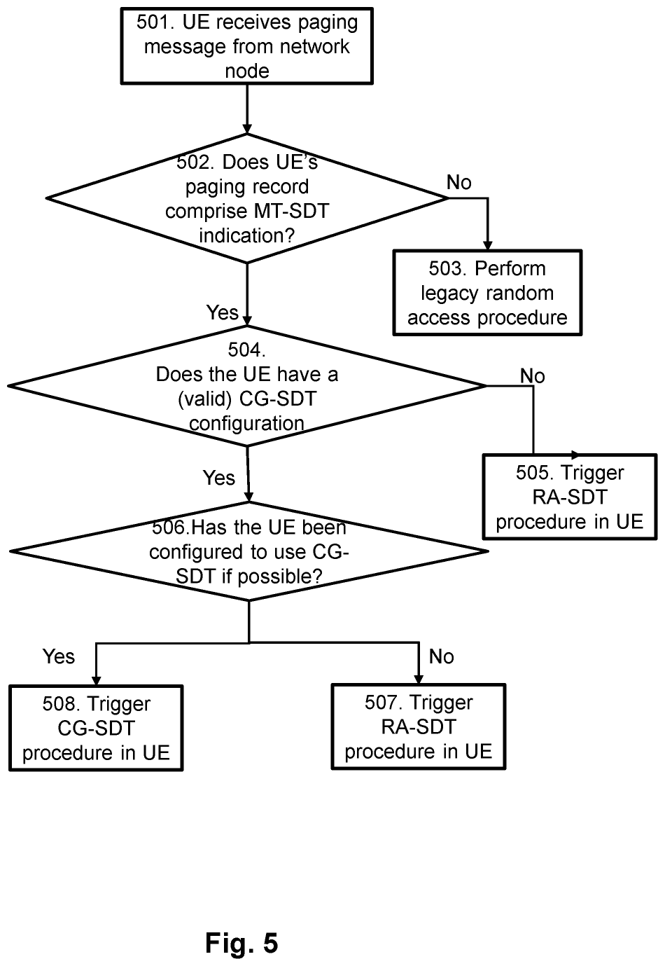

The method may be as illustrated in FIG. 5. Prior to the first step 501 in FIG. 5, the network node 101 has performed steps which corresponds to steps 201 and 202 in FIG. 2 described above. FIG. 5 may relate to a semi-static indication. The method may comprise at least one of the following steps, which steps may be performed in any suitable order than described below:

### Step 501

This step corresponds to step 202 in FIG. 2, step 301 in FIG. 3 and step 401 in FIG. 4. The UE 105 receives a message from the network node 101. The message may be a paging message.

### Step 502

This step corresponds to step 203 in FIG. 2, step 302 in FIG. 3 and step 402 in FIG. 4. Upon reception of the message in step 501, the UE 150 may determine if the message comprises an indication. The indication may be a MT-STD indication. The indication may be comprised in a paging record comprised in the message. If the message comprises an indication, then the method proceeds to step 504, as indicated with “yes” in FIG. 5. If the message does not comprise the indication, then the method proceeds to step 503, as indicated with “no” in FIG. 5

### Step 503

This step corresponds to step 204 in FIG. 2, step 303 in FIG. 3 and step 403 in FIG. 4. This step may be performed if the message does not comprise the indication. The UE 105 may perform a legacy procedure, e.g. a legacy paging procedure, a legacy random access procedure. The paging procedure may be a random access procedure.

### Step 504

This step corresponds to step 203 in FIG. 2. This step may be performed if the message comprises the indication, as indicated with “yes” in FIG. 5. The UE 105 may determine if it comprises a data transmission configuration, e.g. to check if it comprises a valid data transmission configuration. The data transmission configuration may be a CG-SDT configuration.

If the UE 105 comprises the data transmission configuration, then the UE 105 may proceed to step 506, as indicated with “yes” in FIG. 5. If the UE 105 does not comprise the data transmission configuration, then the UE 105 may proceed to step 505, as indicated with “no” in FIG. 5.

### Step 505

This step may be performed if the UE does not comprise the data transmission configuration. The UE 105 may trigger the RA-SDT procedure.

### Step 506

This step may be performed if the UE 105 comprises the data transmission configuration. The UE 105 may determine if the UE 105 has been configured to use the data transmission configuration if possible. If the UE 105 has been configured to use the data transmission configuration, then the UE 105 may perform step 508, as in indicated with “yes” in FIG. 5. If the UE 105 has not been configured to use the data transmission configuration, then the UE 105 may proceed to perform step 507, as indicated with “no” in FIG. 5.

### Step 507

This step may be performed if the UE 105 has not been configured to use the data transmission configuration. The UE 105 may trigger the RA-SDT procedure.

### Step 508

This step may be performed if the UE 105 has been configured to use the data transmission configuration. The UE 105 may trigger the CG-SDT procedure

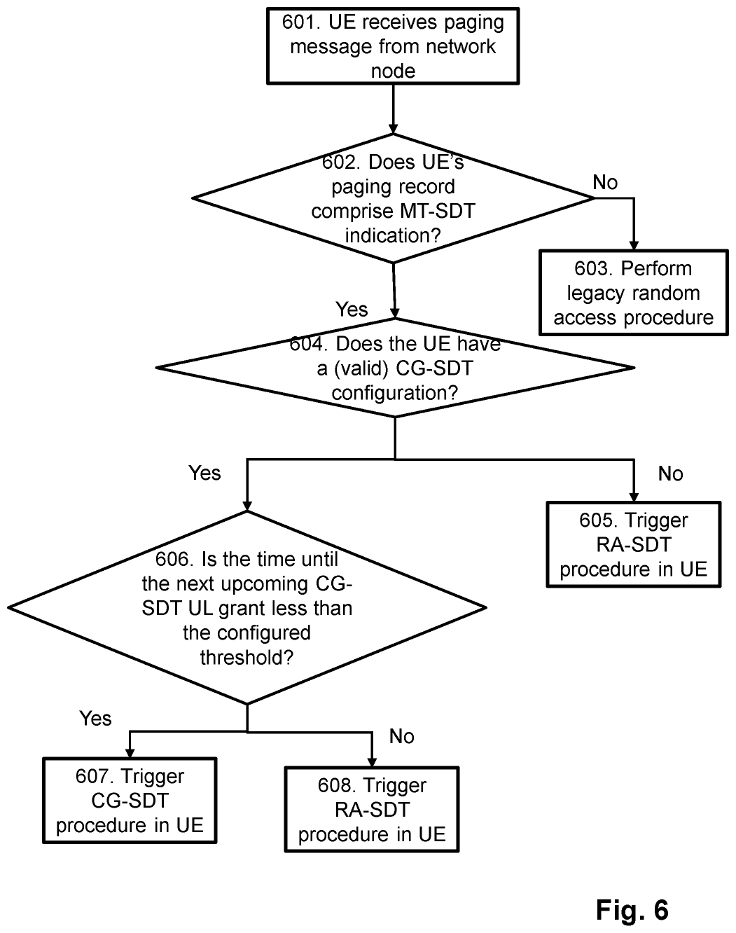

An alternative view of FIG. 5 may be seen in FIG. 6 where there may be a semi-static RRC configuration of how the UE 105 should interpret the MT-SDT indication in the paging record. That is, there may be an indication in paging message for indicating to the UE 105 that it should initiate a procedure for MT-SDT response, where the network node 101 provided RRC signaling would configure the UE 105 to initiate either RA-SDT or CG-SDT.

In one alternative embodiment, a time threshold may be configured for the UE 105 and the UE 105 may only respond to the MT-SDT triggering in the paging message using its configured CG-SDT resources if the time until the upcoming CG-SDT UL grant is below the configured threshold. The threshold may be defined in milliseconds (ms), a number of symbols or slots, number of radio frames or subframes, etc. The threshold may either be UE-specific and provided in dedicated RRC signaling, e.g. in RRCRelease as a Rel-18 extension to the CG-SDT configuration, or it may be a new MT-SDT configuration, or a common threshold may be applied to all UEs 105 in the cell, e.g. signaled in system information.

FIG. 6 may relate to a semi-static indication. FIG. 6 comprises a method where the method comprises at least one of the following steps. Prior to the first step 601 in FIG. 6, the network node 101 has performed steps which corresponds to steps 201 and 202 in FIG. 2 described above. The steps may be performed in any suitable order than described below.

### Step 601

This step corresponds to step 202 in FIG. 2, step 301 in FIG. 3, step 401 in FIG. 4 and step 501 in FIG. 5. The UE 105 receives a message from the network node 101. The message may be a paging message.

### Step 602

This step corresponds to step 203 in FIG. 2, step 302 in FIG. 3, step 402 in FIG. 4 and step 502 in FIG. 5. Upon reception of the message in step 601, the UE 105 may determine if the message comprises an indication. The indication may be a MT-STD indication. The indication may be comprised in a paging record comprised in the message. If the message comprises an indication, then the method proceeds to step 604, as indicated with “yes” in FIG. 6. If the message does not comprise the indication, then the method proceeds to step 603, as indicated with “no” in FIG. 6.

### Step 603

This step corresponds to step 204 in FIG. 2, step 303 in FIG. 3, step 403 in FIG. 4 and step 503 in FIG. 5. This step may be performed if the message does not comprise the indication. The UE 105 may perform a legacy procedure, e.g. a legacy paging procedure, a legacy random access procedure. The paging procedure may be a random access procedure.

### Step 604

This step corresponds to step 203 in FIG. 2 and step 504 in FIG. 5. This step may be performed if the message comprises the indication, as indicated with “yes” in FIG. 6. The UE 105 may determine if it comprises a data transmission configuration, e.g. to check if it comprises a valid data transmission configuration. The data transmission configuration may be a CG-SDT configuration.

If the UE 105 comprises the data transmission configuration, then the UE 105 may proceed to step 606, as indicated with “yes” in FIG. 6. If the UE 105 does not comprise the data transmission configuration, then the UE 105 may proceed to step 605, as indicated with “no” in FIG. 5.

### Step 605

This step corresponds to step 505 in FIG. 5. This step may be performed if the UE 105 does not comprise the data transmission configuration. The UE 105 may trigger the RA-SDT procedure.

### Step 606

This step corresponds to step 203 in FIG. 2 and step 406 in FIG. 4. The UE 105 may determine if the time until the next upcoming CG-SDT UL grant is less than the configured threshold or not.

If the time is less than the configured threshold, then the UE 105 may perform step 607, as indicated with “yes” in FIG. 6. If not less than the configured threshold, i.e. that it is equal to or above the configured threshold, then the UE 105 may perform step 608, as indicated with “no” in FIG. 6.

### Step 607

This step may be performed if the time until the next upcoming CG-SDT UL grant is less than the configured threshold. The UE 105 may trigger the CG-SDT procedure.

### Step 608

This step may be performed if the time until the next upcoming CG-SDT UL grant is not less than the configured threshold. The UE 105 may trigger the RA-SDT procedure.

### Static Determination

In another embodiment, static rules may apply to the UE 105 to determine if the RA-SDT or CG-SDT response should be applied upon the detection of MT-SDT indication in the paging message. The rules may be any combination of the following:
Trigger the use of CG-SDT only in cells 103 belonging to the anchor network node i.e. the network node 101 which transferred the UE to RRC_INACTIVE state by the transmission of the RRCRelease message.
   RA-SDT response is the default in any other cell 103.
The UE 105 may have a CG-SDT configuration in the cell 105, i.e. included for completeness.
Time/latency threshold: Trigger the use of CG-SDT only if the time until the next upcoming CG-SDT UL grant is smaller than a hardcoded time threshold, in unit of e.g. ms, slots, or symbols.
   There may be no hardcoded threshold in the specifications or configured time threshold provided by the network node 101, but the UE 105 may use other means to derive a threshold for determining whether to use the next upcoming CG-SDT UL grant. The UE 105 may derive this threshold, for example, based on information it has on requirements from the used higher layer application, Quality of Service (QOS) settings for the radio bearer, optionally combined with the measured delay or latency between the UE 105 and a network node 101, etc.

The determination may be static in the sense that it is hard-coded, i.e. all UEs 105 do the same when receiving the MT-indication.

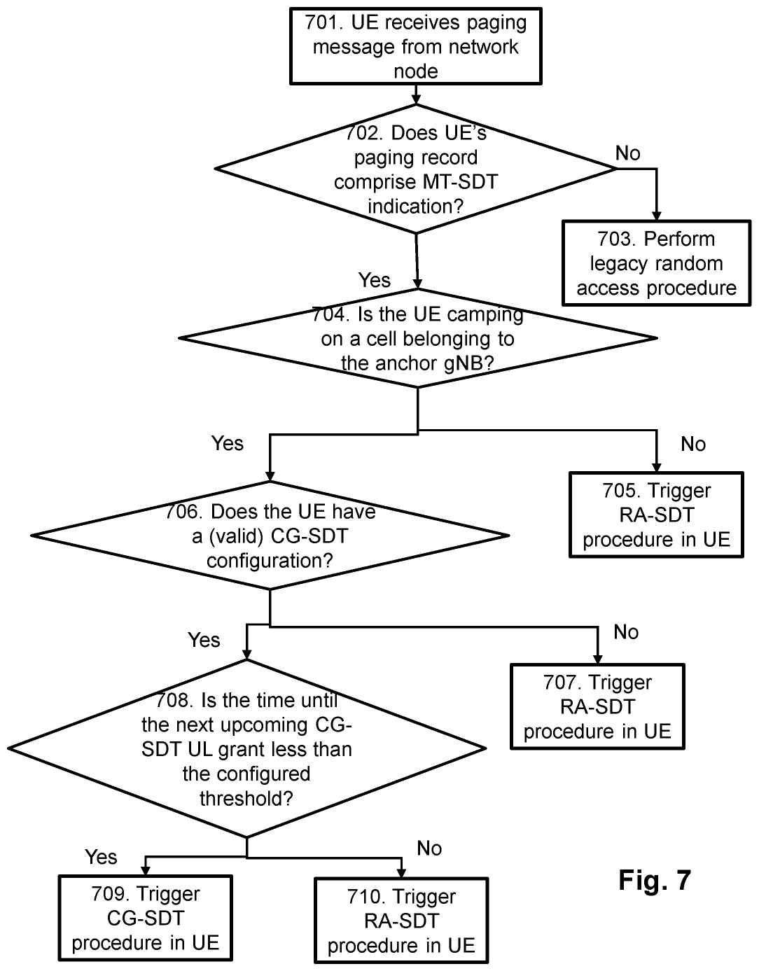

Note that certain conditions may be combined with the methods for the dynamic indication illustrated in FIGS. 3 and 4 and/or the semi-static indication illustrated in FIGS. 5 and 6. For example, any method illustrated in FIGS. 3 and 4 or FIGS. 5 and 6 may be combined with the condition that CG-SDT is only used in the cells 103 of the anchor network node 101. Adding the cell condition to the semi-static configuration in FIGS. 5 and 6, the method may be as illustrated in FIG. 7.

FIG. 7 may relate to a static determination. FIG. 7 comprises a method where the method comprises at least one of the following steps. Prior to the first step 701 in FIG. 7, the network node 101 has performed steps which correspond to steps 201 and 202 in FIG. 2 described above. The steps may be performed in any suitable order than described below.

### Step 701

This step corresponds to step 202 in FIG. 2, step 301 in FIG. 3, step 401 in FIG. 4, step 501 in FIG. 5 and step 601 in FIG. 6. The UE 105 receives a message from the network node 101. The message may be a paging message.

### Step 702

This step corresponds to step 203 in FIG. 2, step 302 in FIG. 3, step 402 in FIG. 4, step 502 in FIG. 5 and step 602 in FIG. 6. Upon reception of the message in step 701, the UE 105 may determine if the message comprises an indication. The indication may be a MT-STD indication. The indication may be comprised in a paging record comprised in the message. If the message comprises an indication, then the method proceeds to step 704, as indicated with “yes” in FIG. 7. If the message does not comprise the indication, then the method proceeds to step 703, as indicated with “no” in FIG. 7.

### Step 703

This step corresponds to step 204 in FIG. 2, step 303 in FIG. 3, step 403 in FIG. 4, step 503 in FIG. 5 and step 603 in FIG. 6. This step may be performed if the message does not comprise the indication. The UE 105 may perform a legacy procedure, e.g. a legacy paging procedure, a legacy random access procedure. The paging procedure may be a random access procedure.

### Step 704

This step may be performed if the message comprises the indication. The UE 105 may determine if the UE 105 is camping on a cell 103 belonging to the anchor network node 101, e.g. gNB, or not. If the UE 105 is camping on the cell belonging to the anchor network node 101, then the method proceeds to step 706 in FIG. 7, as indicated with “yes” in FIG. 7. If the UE 105 is not camping on the cell belonging to the anchor network node 101, i.e. it is camping on another network node 101, then the method proceeds to step 705 in FIG. 7, as indicated with “no” in FIG. 7.

An anchor network node may be described as the network node, e.g. a gNB, where the UE context is saved or located. The anchor network node may typically be the node where the UE 105 was released to inactive.

### Step 705

This step may be performed if the UE 105 is not camping on the cell 103 belonging to the anchor network node 101, i.e. it is camping on another network node 101. The UE 105 may trigger the RA-SDT procedure.

### Step 706

This step may be performed if the UE 105 is camping on the cell 103 belonging to the anchor network node 101. The UE 105 may determine if it has a certain data transmission configuration, e.g. a valid data transmission configuration. The data transmission configuration may be a CG-SDT configuration. If the UE 105 comprises the data transmission configuration, then the UE 105 may proceed to step 708, as indicated with “yes” in FIG. 7. If the UE 105 does not comprise the data transmission, then the UE 105 may proceed to step 707, as indicated with “no” in FIG. 7.

### Step 707

This step may be performed if the UE 105 does not comprise the data transmission. The UE 105 may trigger the RA-SDT procedure.

### Step 708

This step may be performed if the UE 105 comprises the data transmission. The UE 105 may determine if the time until the next upcoming CG-SDT UL grant is less than the configured threshold or not. The UE 105 may proceed to step 709 if the time is less than the configured threshold, as indicated with “yes” in FIG. 7. The UE 105 may proceed to step 710 if the time is not less than, i.e. that is equal to or above, the configured threshold, as indicated with “no” in FIG. 7.

### Step 709

This step may be performed if the time is less than the configured threshold. The UE 105 may trigger the CG-SDT procedure.

### Step 710

This step may be performed if the time is not less than the configured threshold. The UE 105 may trigger the RA-SDT procedure.

That the UE 105 has a valid CG configuration may be taken to mean that a number of conditions are fulfilled for TA validity of the CG resource. These conditions may include any of the following:
A time alignment timer is running.
The Synchronization Signal-Reference Signal Received Power (SS-RSRP) of at least one Synchronization Signal Block (SSB) is above a configured threshold.
The measured RSRP change since a previous reference RSRP value is within a configured change threshold.

### Change of UL Carrier

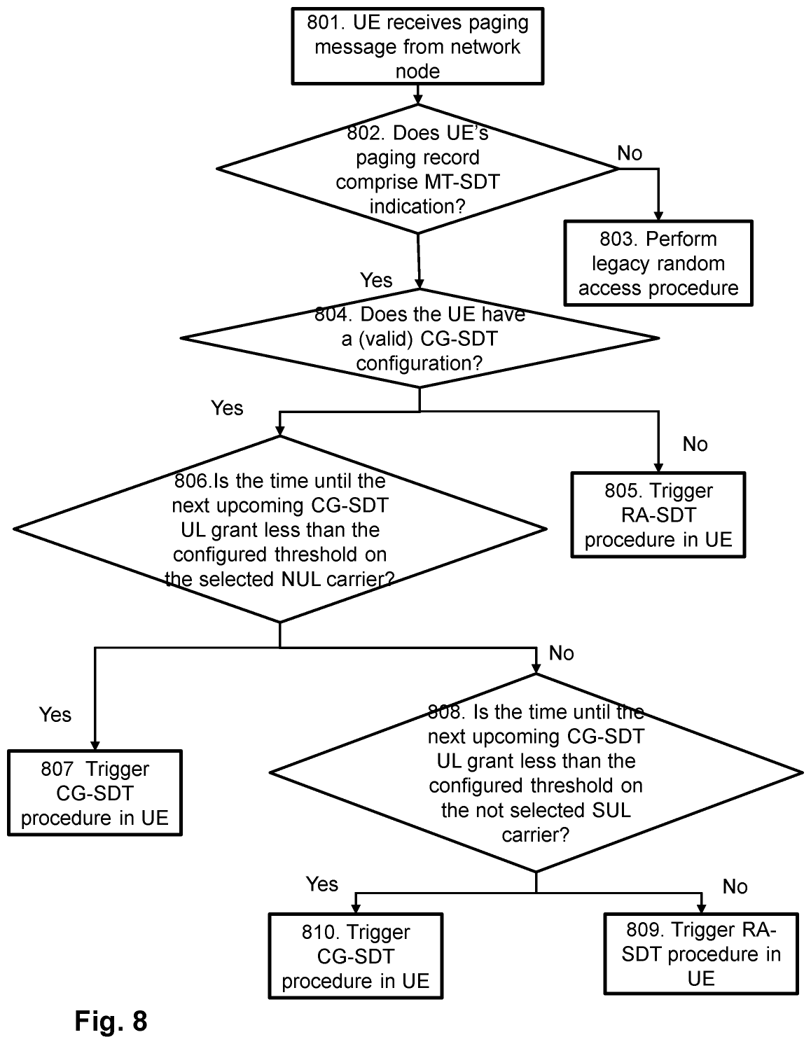

When the UE 105 may be configured with SDT-CG resources on both the normal UL (NUL) and the supplementary UL (SUL), rules may be defined to allow to change from NUL to SUL in case the periodicity of the CG resources is shorter on the SUL and the NUL has initially been selected. This may then mean that if the CG configuration on SUL will satisfy the condition that the time until the next upcoming CG-SDT UL grant on SUL is less than the configured threshold, but the CG configuration on NUL does not satisfy the condition that the time until the next upcoming CG-SDT UL grant on NUL is less than the configured threshold, then the UE is allowed to transmit on SUL. This method is illustrated in FIG. 8.

FIG. 8 illustrates a change of UL carrier. FIG. 8 is a flow chart illustrating a method performed by the UE 105. Prior to the first step in FIG. 8, the network node 101 has performed steps which corresponds to steps 201 and 202 in FIG. 2 described above. The method comprises at least one of the following steps, which steps may be performed in any suitable order than described below:

### Step 801

This step corresponds to step 202 in FIG. 2, step 301 in FIG. 3, step 401 in FIG. 4, step 501 in FIG. 5, step 601 in FIG. 6 and step 701 in FIG. 7. The UE 105 receives a message from the network node 101. The message may be a paging message.

### Step 802

This step corresponds to step 203 in FIG. 2, step 302 in FIG. 3, step 402 in FIG. 4, step 502 in FIG. 5, step 602 in FIG. 6 and step 702 in FIG. 7. Upon reception of the message in step 801, the UE 105 may determine if the message comprises an indication. The indication may be a MT-STD indication. The indication may be comprised in a paging record comprised in the message. If the message comprises an indication, then the method proceeds to step 804, as indicated with “yes” in FIG. 8. If the message does not comprise the indication, then the method proceeds to step 803, as indicated with “no” in FIG. 8.

### Step 803

This step corresponds to step 204 in FIG. 2, step 303 in FIG. 3, step 403 in FIG. 4, step 503 in FIG. 5, step 603 in FIG. 6 and step 703 in FIG. 7. This step may be performed if the message does not comprise the indication. The UE 105 may perform a legacy procedure, e.g. a legacy paging procedure, a legacy random access procedure. The paging procedure may be a random access procedure.

### Step 804

This step may be performed if the message comprises the indication. The UE 105 may determine if it has a certain data transmission configuration, e.g. a valid data transmission configuration. The data transmission configuration may be a CG-SDT configuration. If the UE 105 comprises the data transmission configuration, then the UE 105 may proceed to step 806, as indicated with “yes” in FIG. 8. If the UE 105 does not comprise the data transmission, then the UE 105 may proceed to step 805, as indicated with “no” in FIG. 8.

Step 804 may comprise to determine if the UE 105 has a valid CG-SDT configuration on both NUL and SUL.

### Step 805

This step may be performed if the UE 105 does not comprise the data transmission configuration. The UE 105 may trigger the RA-SDT procedure.

### Step 806

This step may be performed if the UE 105 comprises the data transmission configuration. The UE 105 may determine if the time until the next upcoming CG-SDT UL grant is less than the configured threshold on the selected NUL carrier or not. If the time is less than the configured threshold, then the UE 105 may proceed to step 807, as indicated with “yes” in FIG. 8. If the time is not less than the configured threshold, i.e. that it is equal to or above the threshold, then the UE 105 may proceed to step 808, as indicated with “no” in FIG. 8.

The NUL carrier is selected by the UE 105, e.g. based on RSRP thresholds. It is done before RA-SDT or CG-SDT is triggered. In FIG. 8, the selection of NUL carrier may be performed after step 804.

### Step 807

This step may be performed if the time is less than the configured threshold. The UE 105 may trigger the CG-SDT procedure on the SUL carrier, e.g. the selected SUL carrier.

### Step 808

This step may be performed if the time is not less than the configured threshold. The UE 105 may determine if the time until the next upcoming CG-SDT UL grant is less than the configured threshold on the not selected SUL carrier or not. If the time is less than the configured threshold, then the UE 105 may perform step 810. If the time is not less than, i.e. that is equal to or above, the threshold, then the UE 105 may perform step 809.

### Step 809

This step may be performed if the time is not less than, i.e. that is equal to or above, the threshold. The UE 105 may trigger the RA-SDT procedure.

### Step 810

This step may be performed if the time is less than the threshold. The UE 105 may trigger the CG-SDT procedure, e.g. on the selected SUL carrier.

The steps of FIG. 8 may be combined with the steps in any of the methods illustrated in FIGS. 2-7.

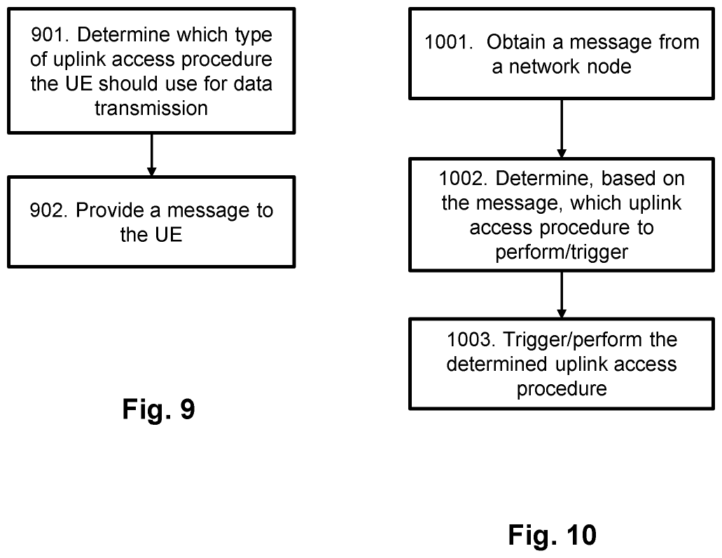

The method described above will now be described seen from the perspective of the network node 101. FIG. 9 is a flowchart describing the present method in the network node 101 for handling uplink access procedures in a communications system 100. The method comprises at least one of the following steps to be performed by the network node 101, which steps may be performed in any suitable order than described below:

### Step 901

This step corresponds to step 201 in FIG. 2. The network node 101 determines which type of uplink access procedure the UE 105 should use for data transmission, e.g. MT data transmission. The type may be a MT type or a legacy type.

### Step 902

The network node 101 provides a message to the UE 105. The message comprises an indication of the determined uplink access procedure to the UE 105 if it is determined that the UE 105 should use the MT type. No indication may be comprised in the message if it is determined that the UE 105 should use the legacy type or a legacy indication may be comprised in the message if it is determined that the UE 105 should use the legacy type.

The message may be a paging message.

The indication may be a MT-SDT indication.

The MT type may be a RA-SDT procedure or a CG-SGT procedure. The MT type may be a first MT type or a second MT type. The first MT type may be a RA-SDT procedure and the second MT type may be a CG-SDT procedure.

The UE 105 may be in inactive state, e.g. RRC inactive state.

The method described above will now be described seen from the perspective of the UE 105. FIG. 10 is a flowchart describing the present method in the UE 105 for handling uplink access procedures in a communications system 100. The method comprises at least one of the following steps to be performed by the UE 105, which steps may be performed in any suitable order than described below:

### Step 1001

This step corresponds to step 202 in FIG. 2. The UE 105 obtains a message from a network node 101.

The message may comprise an indication of an uplink access procedure if the UE 105 should use a MT type

### Step 1002

This step corresponds to step 203 in FIG. 2. The UE 105 determines, based on the message, which type of uplink access procedure the UE 105 should be used for data transmission. The type is the MT type or a legacy type. Using other words, the UE 105 determines, based on the message, which uplink access procedure to perform or trigger.

### Step 1003

This step corresponds to step 204 in FIG. 2. The UE 105 triggers the data transmission using the determined uplink access procedure. This may be described as the UE 105 performs the data transmission using the determined uplink access procedure.

To perform the method steps shown in FIGS. 2-8 and 10 for handling uplink access procedures in a communications system 100, the UE 105 may comprise an arrangement as shown in FIG. 100a and/or 100b. The UE 105 is arranged to perform the method as described herein.

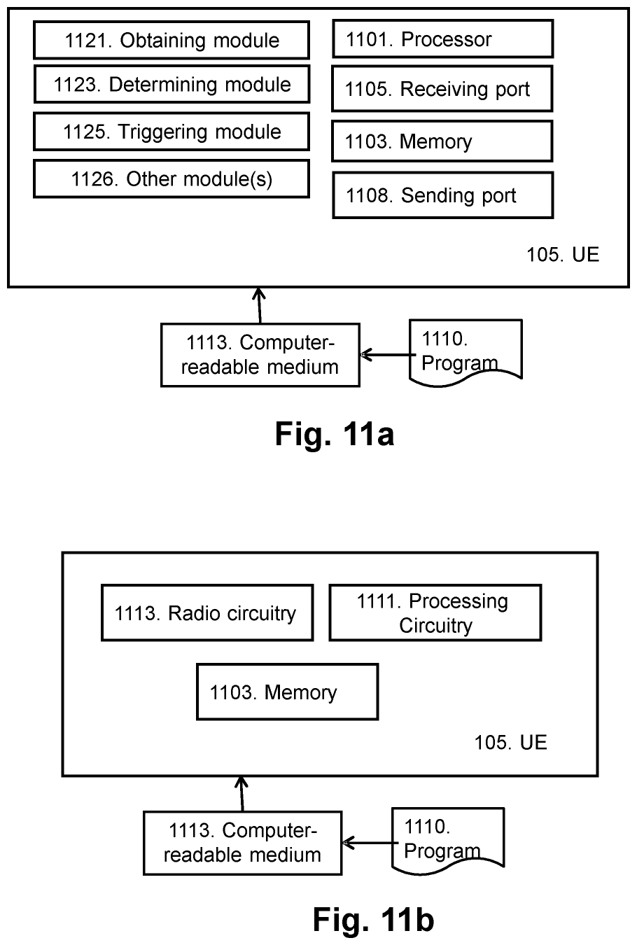

The present mechanism for handling uplink access procedures in a communications system 100 may be implemented through one or more processors, such as a processor 1101 in the arrangement depicted in FIG. 11a and/or 11b, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the UE 105. One such carrier may be in the form of a CD ROM disc. It is however feasible with other data carriers such as a memory stick. The computer program code can be provided as pure program code on a server and downloaded to the UE 105.

FIG. 11a and FIG. 11b depict two different examples in panels a) and b), respectively, of the arrangement that the UE 105 may comprise. The UE 105 may comprise the following arrangement depicted in FIG. 11a.

The present disclosure related to the UE 105 may be implemented through one or more processors, such as a processor 1101 in the UE 105 depicted in FIG. 11a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 105. One such carrier may be in the form of a CD ROM disc. It is however feasible with other data carriers such as a memory stick. The computer program code may be provided as pure program code on a server and downloaded to the UE 105.

The UE 105 may comprise a memory 1103 comprising one or more memory units. The memory 1103 is arranged to be used to store obtained information, store data, configurations, schedulings, and applications etc. to perform the methods herein when being executed in the UE 105.

The UE 105 may receive information from, e.g. the network node 101, through a receiving port 1105. The receiving port 1105 may be, for example, connected to one or more antennas in UE 105. The UE 105 may receive information from another structure in the communications system 100 through the receiving port 1105. Since the receiving port 1105 may be in communication with the processor 1101, the receiving port 1105 may then send the received information to the processor 1101. The receiving port 1105 may also be configured to receive other information.

The processor 1101 in the UE 105 may be configured to transmit or send information to e.g. network node 101 or another structure in the communications system 100, through a sending port 1108, which may be in communication with the processor 1101, and the memory 1103.

The UE 105 may comprise an obtaining module 1121, a determining module 1123, a triggering module 1125, and other module(s) 1126 etc.

Those skilled in the art will also appreciate that the obtaining module 1121, the determining module 1123, the triggering module 1125, and other module(s) 1126 described above may refer to a combination of analogue and digital circuits, and/or one or more processors configured with software and/or firmware, e.g., stored in memory, that, when executed by the one or more processors such as the processor 1101, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different modules 1121-1126 described above may be implemented as one or more applications running on one or more processors such as the processor 1101.

Thus, the methods described herein for the UE 105 may be respectively implemented by means of a computer program 1110 product, comprising instructions, i.e., software code portions, which, when executed on at least one processor 1001, cause the at least one processor 1101 to carry out the actions described herein, as performed by the UE 105. The computer program 1110 product may be stored on a computer-readable storage medium 1113. The computer-readable storage medium 1113, having stored thereon the computer program 1110, may comprise instructions which, when executed on at least one processor 1101, cause the at least one processor 1101 to carry out the actions described herein, as performed by the UE 105. The computer-readable storage medium 1113 may be a non-transitory computer-readable storage medium, such as a CD ROM disc, or a memory stick. The computer program 1110 product may be stored on a carrier containing the computer program 1110 just described, wherein the carrier is one of an electronic signal, optical signal, radio signal, or the computer-readable storage medium 1113, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 11b. The UE 105 may comprise a processing circuitry 1111, e.g., one or more processors such as the processor 1101, in the UE 105 and the memory 1103. The UE 105 may also comprise a radio circuitry 1113, which may comprise e.g., the receiving port 1105 and the sending port 1108. The processing circuitry 1111 may be configured to, or operable to, perform the method actions according to FIGS. 2-8 and 10. in a similar manner as that described in relation to FIG. 100a. The radio circuitry 1113 may be configured to set up and maintain at least a wireless connection with the UE 105. Circuitry may be understood herein as a hardware component.

Hence, the present disclosure also relates to the UE 105 operative to operate in the communications system 100. The UE 105 may comprise the processing circuitry 1111 and the memory 1103. The memory 1103 comprises instructions executable by said processing circuitry 1111. The UE 105 is operative to perform the actions described herein in relation to the UE 105, e.g., in FIGS. 2-8 and 10.

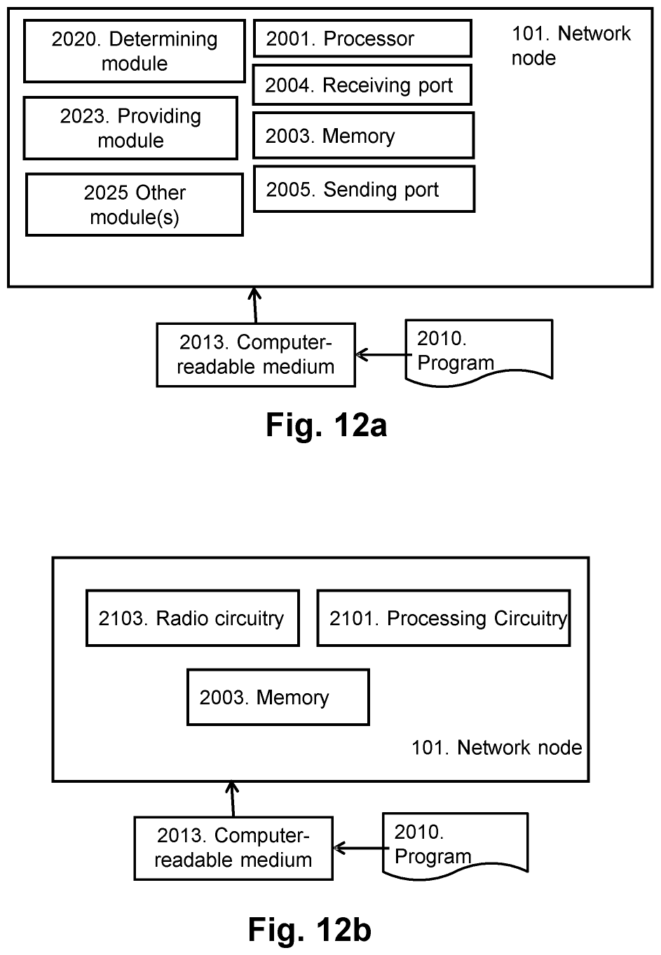

FIGS. 12a and FIG. 200b depict two different examples in panels a) and b), respectively, of the arrangement that the network node 101 may comprise. The network node 101 may comprise the following arrangement depicted in FIG. 12a.

The present disclosure associated with the network node 101 may be implemented through one or more processors, such as a processor 2001 in the network node 101 depicted in FIG. 12a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 2003 comprising one or more memory units. The memory 2003 is arranged to be used to store obtained information, store data, configurations, schedulings, and applications etc. to perform the methods herein when being executed in the network node 101.

The network node 101 may receive information from, e.g., the UE 105, through a receiving port 2004. The receiving port 2004 may be, for example, connected to one or more antennas in network node 101. The network node 101 may receive information from another structure in the communications system 100 through the receiving port 2004. Since the receiving port 2004 may be in communication with the processor 2001, the receiving port 2004 may then send the received information to the processor 2001. The receiving port 2004 may also be configured to receive other information.

The processor 2001 in the network node 101 may be configured to transmit or send information to e.g., the UE 105, or another structure in the communications system 100, through a sending port 2005, which may be in communication with the processor 2001, and the memory 2003.

The network node 101 may comprise a determining module 2020, a providing module 2023 and other module(s) 2025.

Those skilled in the art will also appreciate that the determining module 2020, the providing module 2023 and other module(s) 2025 etc. described above may refer to a combination of analog and digital circuits, and/or one or more processors configured with software and/or firmware, e.g., stored in memory, that, when executed by the one or more processors such as the processor 2001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 2020-2025 described above may be implemented as one or more applications running on one or more processors such as the processor 2001.

Thus, the methods described herein for the network node 101 may be respectively implemented by means of a computer program 2010 product, comprising instructions, i.e., software code portions, which, when executed on at least one processor 2001, cause the at least one processor 2001 to carry out the actions described herein, as performed by the network node 101. The computer program 2010 product may be stored on a computer-readable storage medium 2013. The computer-readable storage medium 2013, having stored thereon the computer program 2010, may comprise instructions which, when executed on at least one processor 2001, cause the at least one processor 2001 to carry out the actions described herein, as performed by the network node 101. The computer-readable storage medium 2013 may be a non-transitory computer-readable storage medium, such as a CD ROM disc, or a memory stick. The computer program 2010 product may be stored on a carrier containing the computer program 2010 just described, wherein the carrier is one of an electronic signal, optical signal, radio signal, or the second computer-readable storage medium 2013, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 12b. The network node 101 may comprise a processing circuitry 2101, e.g., one or more processors such as the processor 2001, in the network node 101 and the memory 2003. The network node 101 may also comprise a radio circuitry 2103, which may comprise e.g., the receiving port 2004 and the sending port 2005. The processing circuitry 2101 may be configured to, or operable to, perform the method actions according to FIG. 2-9 in a similar manner as that described in relation to FIG. 12a. The radio circuitry 2103 may be configured to set up and maintain at least a wireless connection with the network node 101. Circuitry may be understood herein as a hardware component.

The network node 101 may be operative to operate in the communications system 100. The network node 101 may comprise the processing circuitry 2101 and the memory 2003. The memory 2003 comprises instructions executable by the processing circuitry 2101. The network node 101 is operative to perform the actions described herein in relation to the network node 101, e.g., in FIGS. 2-9.

### Further Extensions and Variations

A telecommunication network may be connected via an intermediate network to a host computer.

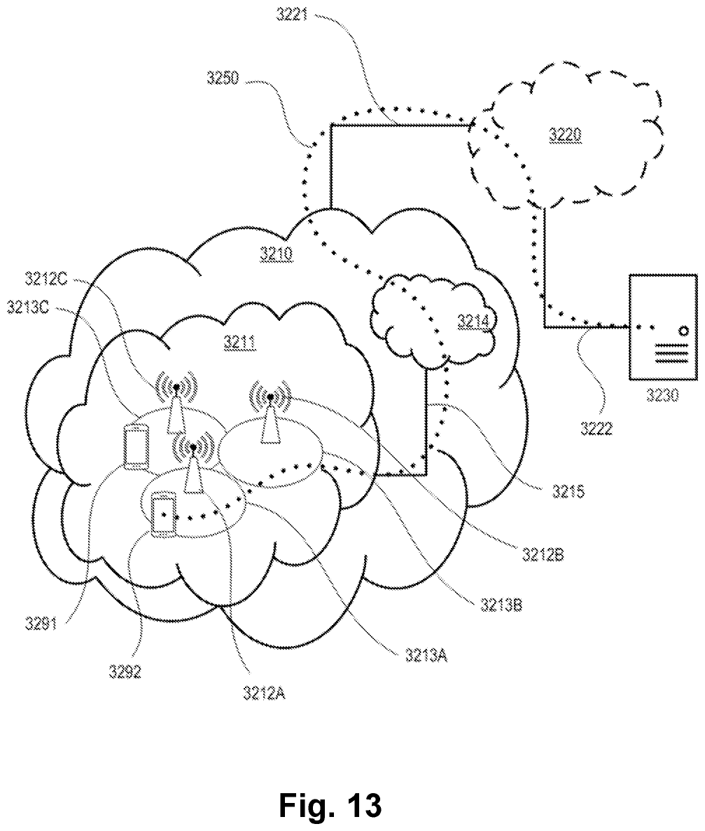

With reference to FIG. 13, a communication system comprises telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 320, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 13 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

In relation to FIGS. 13-18 which are described next, it may be understood that the base station may be considered an example of the network node 101.

FIG. 14 illustrates an example of host computer communicating via a network node 101 with a UE 105 over a partially wireless connection.

The UE 105 and the network node 101, e.g., a base station and host computer discussed in the preceding paragraphs will now be described with reference to FIG. 14. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 14 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 14 as a UE 3330 located in a coverage area served by base station 3320. Communication interface 3326 may be configured to facilitate connection 3360 to host computer 3310. Connection 3360 may be direct, or it may pass through a core network (not shown in FIG. 14) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 320, respectively. This is to say, the inner workings of these entities may be as shown in FIG. 14 and independently, the surrounding network topology may be that of FIG. 13.

In FIG. 14, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g. based onload balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or dummy messages, using OTT connection 3350 while it monitors propagation times, errors etc.

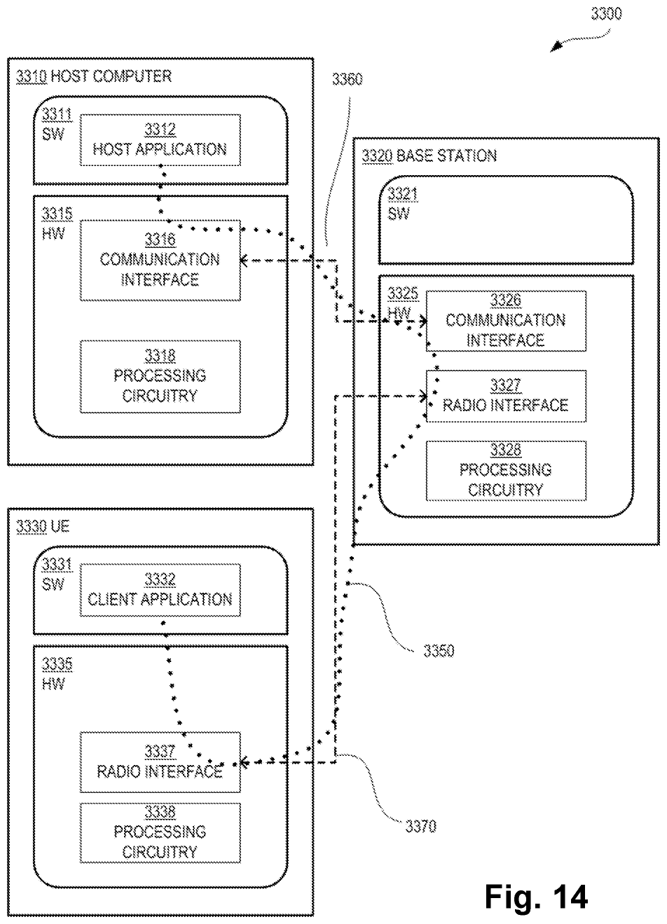

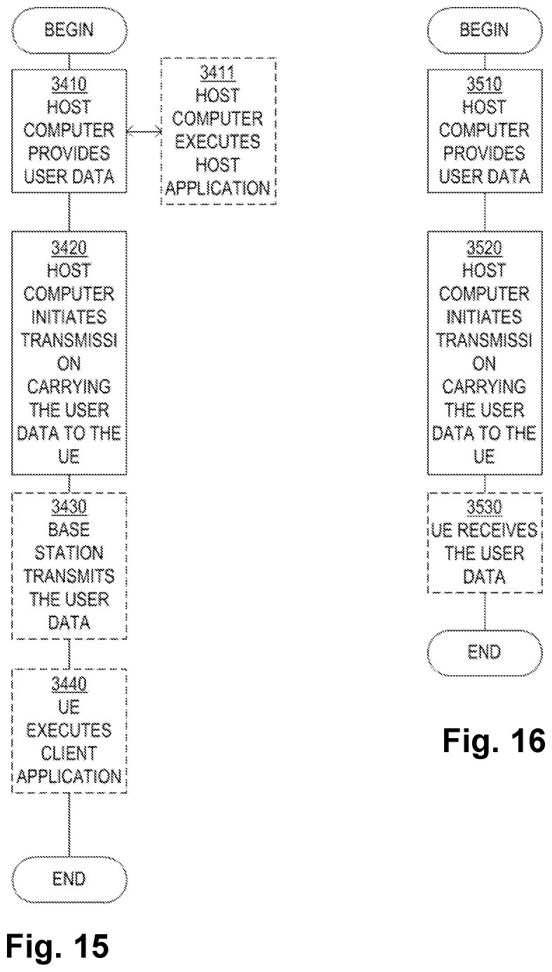

FIG. 15 illustrates an example of methods implemented in a communication system comprising a host computer, a base station and a UE 105. FIG. 15 is a flowchart illustrating a method implemented in a communication system. The communication system comprises a host computer, a base station and a UE 105 which may be those described with reference to FIG. 14 and FIG. 14. For simplicity of the present disclosure, only drawing references to FIG. 15 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may also be optional), the UE executes a client application associated with the host application executed by the host computer.

FIG. 16 illustrates methods implemented in a communication system comprising a host computer, a base station and a UE 105. FIG. 16 is a flowchart illustrating a method implemented in a communication system. The communication system comprises a host computer, a base station and a UE 105 which may be those described with reference to FIG. 320 and FIG. 330. For simplicity of the present disclosure, only drawing references to FIG. 350 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

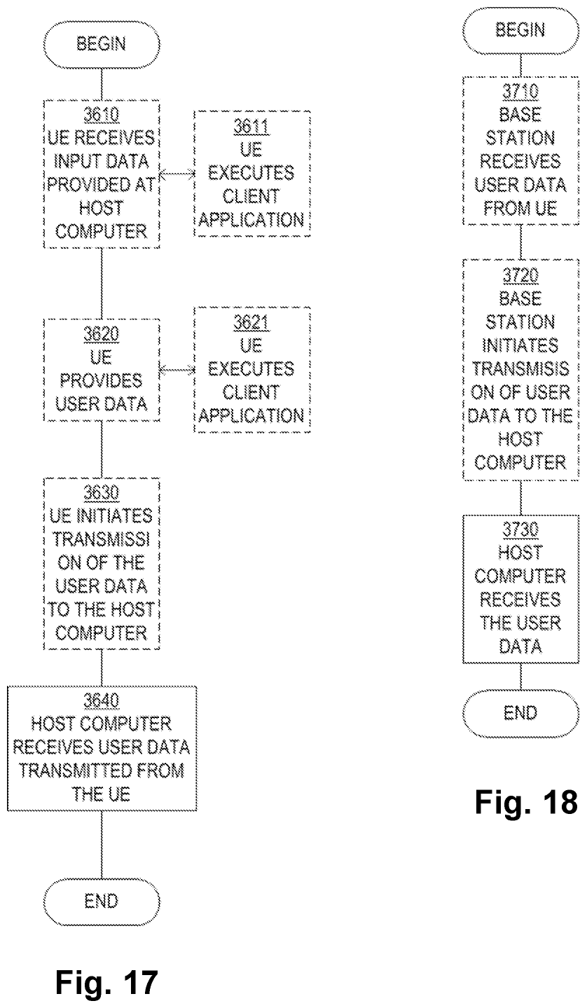

FIG. 17 illustrates methods implemented in a communication system comprising a host computer, a base station and a UE 105. FIG. 17 is a flowchart illustrating a method implemented in a communication system. The communication system comprises a host computer, a network node 101 and a UE 105 which may be those described with reference to FIG. 320 and FIG. 330. For simplicity of the present disclosure, only drawing references to FIG. 360 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 18 illustrates methods implemented in a communication system comprising a host computer, a base station and a UE 105. FIG. 18 is a flowchart illustrating a method implemented in a communication system. The communication system comprises a host computer, a base station and a UE 105 which may be those described with reference to FIG. 320 and FIG. 330. For simplicity of the present disclosure, only drawing references to FIG. 370 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and.
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,.
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a network node for handling uplink access procedures in a communications system, the method comprising:
determining which type of uplink access procedure a User Equipment, UE, should use for data transmission, wherein the type is a Mobile Terminated, MT, type or a legacy type; and
providing a message to the UE, wherein the message comprises an indication of the determined uplink access procedure to the UE if it is determined that the UE should use the MT type.

2. The method according to claim 1, wherein no indication is comprised in the message if it is determined that the UE should use the legacy type, or wherein a legacy indication is comprised in the message if it is determined that the UE should use the legacy type.

3. The method according to claim 1, wherein the message comprises a first indication if the UE should use the MT type and the message comprises a second indication if the UE should use the legacy type.

4. The method according to claim 1, wherein the indication is a Mobile Terminated-Small Data Transmission, MT-SDT, indication.

5. The method according to claim 1, wherein the MT type is a Random Access-Small Data Transmission, RA-SDT, procedure or a Configured Grant-Small Data Transmission, CG-SDT, procedure.

6. A method performed by a User Equipment, UE, for handling uplink access procedures in a communications system, the method comprising:
obtaining a message from a network node, wherein the message comprises an indication of an uplink access procedure if the UE should use a Mobile Terminated, MT, type;
determining, based on the message, which type of uplink access procedure the UE should be used for data transmission, wherein the type is the MT type or a legacy type; and
triggering the data transmission using the determined uplink access procedure.

7. The method according to claim 6, wherein no indication is comprised in the message if the UE should use the legacy type, or wherein a legacy indication is comprised in the message if the UE should use the legacy type.

8. The method according to claim 6, wherein the message comprises a first indication if the UE should use the MT type and the message comprises a second indication if the UE should use the legacy type.

9. The method according to claim 6, wherein the indication is a Mobile Terminated-Small Data Transmission, MT-SDT, indication.

10. The method according to claim 6, wherein the MT type is a Random Access-Small Data Transmission, RA-SDT, procedure or a Configured Grant-Small Data Transmission, CG-SDT, procedure.

11. The method according to claim 6, comprising:
if the message does not comprise the indication or if the message comprises the legacy indication, triggering the legacy type of uplink access procedure;
if the message comprises the indication, determining, based on the indication, if a first type or a second type of the MT type of uplink access procedure should be triggered; and
triggering the first type or the second type, as determined.

12. The method according to claim 6, comprising:
if the message comprises the indication, determining if the indication comprises a first value or not, and
wherein the determining which uplink access procedure the UE should use is based on the indication comprising the first value or not.

13. The method according to claim 6, comprising:
determining if a time until a next upcoming Configured Grant-Small Data Transmission, CG-SDT, Uplink, UL, grant is less than a configured threshold or not, and
wherein the determining which uplink access procedure the UE should use is based on the time until the next upcoming CG-SDT UL grant being less than the configured threshold or not.

14. The method according to claim 13, wherein the time until the next upcoming CG-SDT UL grant is associated with a selected Normal Uplink, NUL, carrier or a not selected Supplementary Uplink, SUL, carrier.

15. The method according to claim 6, comprising:
determining if the UE comprises a data transmission configuration, and
wherein the determining which uplink access procedure the UE should use is based on the UE comprising the data transmission configuration.

16. The method according to claim 6, comprising:
determining if the UE has been configured to use a Configured Grant-Small Data Transmission, CG-SDT, and
wherein the determining which uplink access procedure the UE should use is based on the UE having been configured to use the CG-SDT.

17. The method according to claim 6, comprising:
determining if the UE is camping on a cell belonging to the network node or not, and
wherein the determining which uplink access procedure the UE should use is based on the UE camping on a cell belonging to the network node or not.

18. A network node for handling uplink access procedures in a communications system , wherein the network node is configured to perform a method according to claim 1.

19. A User Equipment, UE, for handling uplink access procedures in a communications system, wherein the UE is configured to perform a method according to claim 6.

20. (canceled)

21. (canceled)
